(19) United States
(12) Patent Application Publication
(10) Pub. No.: US 2008/0299943 A1
(43) Pub. Date: Dec. 4, 2008

(54) APPARATUSES, METHODS, AND COMPUTER PROGRAM PRODUCTS FOR DETERMINING A CHARGE FOR INFORMATIONAL MATERIAL

(75) Inventors: Quinn Jacobson, Sunnyvale, CA (US); Govind Krishnamurthi, San Mateo, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/757,602

(22) Filed: Jun. 4, 2007

(51) Int. Cl. H04M 11/00

(52) U.S. Cl. 455/406

(57) ABSTRACT

Provided is an apparatus for determining a charge to an entity associated with informational material disseminated to at least one mobile terminal. The apparatus includes a processing unit that may be configured to obtain respective location data of the mobile terminal during and subsequent to rendering of the informational material at the mobile terminal. A billing unit may be configured to determine a charge to an entity associated with the informational material based at least in part on movement of the at least one mobile terminal subsequent to rendering of the informational material as indicated by the location data. Corresponding methods and computer program products are also provided.

### FIELD OF THE DISCLOSURE

Embodiments of the present invention relate generally to apparatuses, methods, and computer program products for providing informational material, and to apparatuses, methods, and computer program products for determining a charge to an entity associated with informational material that has been disseminated to one or more mobile terminals.

### BACKGROUND

Many companies, especially those involved in communications media, generate revenue by providing an advertising platform that others may use for a fee. Traditional examples of this practice include television broadcasters, which sell commercial air time, and various Internet-based entities, which sell advertising space within web pages. Various models exist to determine the appropriate price for such advertising opportunities. One model, termed the “cost-per-thousand” model, ties the price to the number of consumers expected to be exposed to the resulting advertisement. This model explains, for example, the high cost associated with procuring advertisement air time during the Superbowl. Another model, termed the “pay-per-call” or “pay-per-click” model, attempts to relate advertising cost to the actual number of consumers that are exposed to the advertisement by accruing a unit charge for each time an advertised number is called or an advertised hyperlink is clicked. Still another model exists, called the “cost-per-acquisition” model. In this last case, advertising price is determined by accruing a unit charge each time there is an act of “consumption,” whether that act is to purchase an advertised product or to take some other affirmative step toward a transaction (e.g., registration, printing a voucher, etc.).

Generally, the above described models for determining advertising price attempt to set price based on a measure of advertising effectiveness. However, each model chooses a different proxy for advertising effectiveness, whether it be an expected audience size, a tangible measure of actual exposure, or a measure of consumption. While each of these models has found use in, and may be most appropriate for, various applications, each also provides an imperfect method for pricing that does not account fully for the effectiveness of an advertisement.

### BRIEF SUMMARY

In light of the foregoing background, embodiments of apparatuses, methods, and computer program products are provided for determining a charge to an entity associated with informational material that has been disseminated to at least one mobile terminal. The charge is determined based, at least in part, on movement of the mobile terminal subsequent to rendering of the informational material. Establishing such a relationship between charge and mobile terminal movement may serve to characterize the effectiveness of the informational material in motivating conduct.

According to one aspect, an apparatus is provided that includes a processing unit and a billing unit. The processing unit may be configured to obtain respective location data of at least one mobile terminal during and, possibly for a specified time, subsequent to rendering of informational material at the mobile terminal. The billing unit may be configured to determine a charge to an entity associated with the informational material based at least in part on movement of the at least one mobile terminal subsequent to rendering of the informational material as indicated by the location data. For example, the billing unit may be configured to determine the charge based on mobile terminal movement subsequent to rendering of the informational material and relative to a product location of a product to which the informational material is related. The apparatus may also include a communications unit configured to disseminate the informational material to the mobile terminal. The communications unit may be further configured to disseminate at least one rule associated with the informational material, the rule specifying a relationship between the charge to the entity associated with the informational material and movement of the mobile terminal subsequent to rendering of the informational material.

In one embodiment, the apparatus may be associated with a network accessible to the mobile terminal via any of multiple network access points. The processing unit may then be configured to obtain respective location data of the mobile terminal during and subsequent to rendering of the informational material at the mobile terminal by respectively identifying, for times during and subsequent to rendering of the informational material, a specific one of the network access points via which the mobile terminal is connected to the network. In another embodiment, the communications unit may be configured to receive messages from the mobile terminal, at least some of the messages including location data for the at least one mobile terminal, and said processing unit is configured to obtain the location data from the messages.

In still another embodiment, the apparatus may include a memory unit configured to store at least one rule specifying a relationship between the charge to the entity associated with the informational material and movement of the mobile terminal, or in some cases multiple rules each specifying the charge to the entity associated with the informational material as a function of at least the movement of the mobile terminal and an identity of the entity. In yet another embodiment, the processing unit includes processing means for obtaining respective location data of the mobile terminal during and subsequent to rendering of informational material at the at least one mobile terminal, and the billing unit includes billing means for determining a charge to an entity associated with the informational material based at least in part on movement of the mobile terminal subsequent to rendering of the informational material as indicated by the location data.

According to another aspect, a method is provided that includes obtaining respective location data of at least one mobile terminal during and subsequent to rendering of informational material at the mobile terminal. A charge to an entity associated with the informational material may be determined based at least in part on movement of the mobile terminal subsequent to rendering of the informational material as indicated by the location data. For example, the charge may be determined based on mobile terminal movement subsequent to rendering of the informational material at the mobile terminal and relative to a product location of a product to which the informational material is related.

According to yet another aspect, a computer program product is provided that includes a computer-readable storage medium having computer-readable program code portions stored therein. The computer-readable program code portions include a first executable code portion for obtaining respective location data of at least one mobile terminal during and subsequent to rendering of informational material at the mobile terminal. Also included is a second executable code portion for determining a charge to an entity associated with the informational material based at least in part on movement of the mobile terminal subsequent to rendering of the informational material, for example, relative to a product location of a product to which the informational material is related.

According to still another aspect, an apparatus is provided that includes a communications unit configured to receive informational material via a network. The informational material may be rendered via an output unit configured therefor. The apparatus also includes a processing unit configured to cause, in response to rendering of the informational material, an indication of locations of the apparatus during and subsequent to rendering of the informational material to be transmitted via the communications unit over the network to a billing unit. The apparatus may further include a positioning system in communication with the communications unit. The apparatus may further include a memory unit in communication with the processing unit and the communications unit.

The communications unit may be configured to receive, and the memory unit may be configured to store, at least one rule associated with the informational material, the rule specifying a relationship between a charge to an entity associated with the informational material and movement of said apparatus subsequent to rendering of the informational material. Also, the processing unit may be configured to execute instructions associated with the rule in causing the indication of locations of the apparatus to be transmitted to the billing unit.

In some embodiments, the communications unit may include communications means for receiving informational material via a network. The output unit may include output means for rendering the informational material. The processing unit may include processing means for causing, in response to rendering of the informational material, an indication of locations of the apparatus during and subsequent to rendering of the informational material to be transmitted via the communications unit over the network to the billing unit.

In one embodiment, the network may be accessible via any of multiple network access points. The processing unit may be configured to cause, in response to rendering of the informational material, transmission to the billing unit via the communications unit of respective communications at times during and subsequent to rendering of the informational material. The billing unit may then determine location data for the apparatus by respectively identifying, for each of the communications, a specific one of the network access points via which the communications unit accessed the network. In another embodiment, the processing unit may be configured to cause, in response to rendering of the informational material, respective location data for the apparatus during and subsequent to rendering of the informational material to be transmitted via the communications unit over the network to the billing unit. The respective location data may be transmitted substantially immediately after the time to which the respective location data pertain.

Another aspect is directed to a computer program product that includes a computer-readable storage medium having computer-readable program code portions stored therein. The computer-readable program code portions are executable on an apparatus and include a first executable code portion for receiving informational material via a network. A second executable code portion is also included for rendering the informational material. A third executable code portion causes, in response to rendering of the informational material, an indication of locations of the apparatus during and subsequent to rendering of the informational material to be transmitted by the apparatus over the network to a billing unit.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B are schematic views of a communications system configured in accordance with an embodiment;

FIGS. 2A and 2B are schematic views of a communications system configured in accordance with another embodiment; and

FIG. 3 is a flowchart representing a method for utilizing the communications system of FIGS. 2A and 2B, the method being in accordance with an embodiment.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

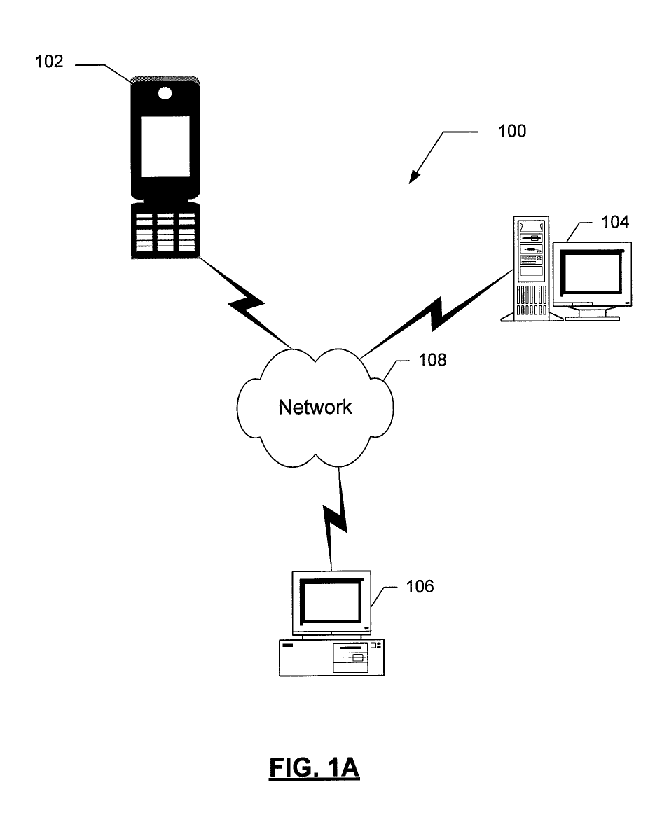

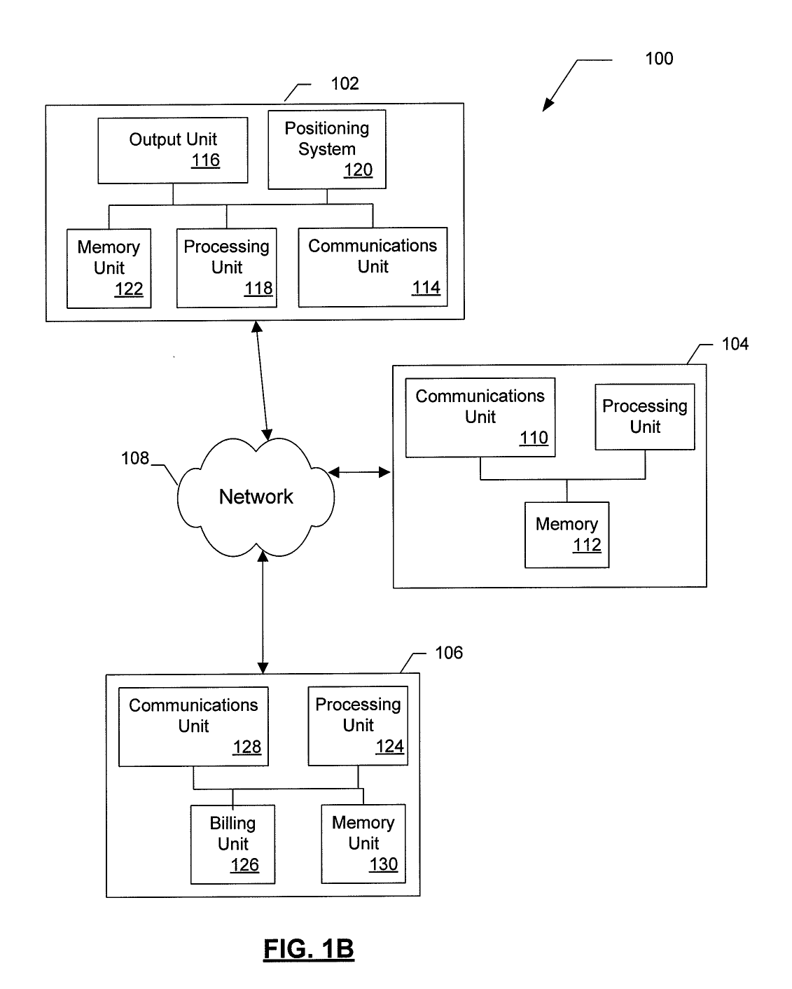

Referring to FIGS. 1A and 1B, therein is schematically shown a communications system 100 configured in accordance with one embodiment of the invention. The communications system 100 includes at least one mobile terminal, such as cellular telephone 102, a server 104, and a computer 106, all of which may communicate with one another via a communications network (or simply “network”) 108. It should be understood that communications system 100 may include multiple mobile terminals that are each respectively capable of communicating via network 108, and that the mobile terminals 102 may be selected from any of a variety and combination of mobile digital devices, such as portable digital assistants (PDAs), cellular telephones, pagers, mobile communications devices, mobile computers, mobile televisions, radio broadcasting receivers, gaming devices, laptop computers, cameras, video recorders, audio/video players, global positioning system (GPS) devices, and/or other types of voice and text communications systems. Communications system 100 may include disparate types of mobile terminals.

It should also be understood that the network 108 may include one or more different networks that may be connected to each other and capable of disseminating the informational material, such one or more different network types possibly including one or more of a wireless/cellular telecommunications network, a wireless local area network (WLAN), a wide area network (WAN), the Internet, a Bluetooth® network, a Worldwide Interoperability for Microwave Access (WiMAX) network, a WiBree network, an ultra-wideband (UWB) network, an infrared access network, a radio-frequency indentification (RFID) network, a low power radio network, and a short range communication network. Additionally, the communications network 108 may include also digital radio and/or television broadcasting networks, such as a Digital Video Broadcasting (DVB) network, a DVB-handheld (DVB-H) network, an IP datacasting (IPDC) network, a DVB-terrestrial (DVB-T) network, a MediaFLO network, a Digital Audio Broadcasting (DAB) network, a Digital Multimedia Broadcasting (DMB) network, a Digital Radio Mondiale (DRM) network, etc. Alternatively, the network 108 may be, in some cases, also be a wired network access.

Server 104 may disseminate via network 108 various types of informational material for receipt by one or more mobile terminals, such as cellular telephone 102. Server 104 may include a communications unit 110 that incorporates, for example, a network connection and a processor and thereby facilitates communication over network 108. Server 104 may disseminate the informational material specifically to a mobile terminal, such as cellular telephone 102, or the informational material may be distributed to all devices with which network 108 is capable of communicating. In the case of targeted transmissions, specific mobile terminals may be chosen to receive the informational material, for example, based on previously collected information about the user of cellular telephone 102, which may be stored in a memory 112 along with a listing of access information (e.g., telephone numbers or electronic mail addresses) and functionalities (e.g., processing capabilities, rendering capabilities) for the mobile terminals with which server 104 communicates. Specific mobile terminals may also be targeted to receive certain informational material based on the physical location of each mobile terminal, with location being determined as described below.

The term “informational material” generally refers to material that has some communicative capability. In some cases, informational material may relate to at least one product, where the term product is understood to refer to any item, service, experience, or combination thereof that may be available to some portion of the population, whether for purchase or otherwise. The informational materials may be associated with at least one entity, which may be, for example, the entity associated with the content of the informational material (e.g., a manufacturer of an advertised product), the entity responsible for creating the informational material, and/or the entity responsible for distributing the informational material. Of course, some or all of these entities could be the same entity. Some examples of informational material include advertising materials regarding the commercial sale of a component or the offering of services for a fee, evaluations performed by a third party entity regarding the performance of various devices offered for sale, promotional information regarding public or private destinations (e.g., a promotion related to a feature at a public park), digital vouchers or coupons, and/or materials supporting a political position or candidate. The informational material may be stored for subsequent dissemination in an informational material database, which may coincide with or be contained in memory 112. Additionally, the informational material may include metadata information, such as an informational material identification (ID) number, a sender ID, sender contact information, a location data address or billing data address (to be described below), a “billing impulse” address or entity (the term “billing impulse” is described below), billing impulse-triggering locations (e.g., one or more access point IDs or location coordinates, where “access point” is described below), a validity time period, etc. Also, the informational material may include a rule that defines certain actions relating to the informational material as a function of, amongst other factors, determined time and location information.

Cellular telephone 102 may include communications means, such as a communications unit 114, configured and capable to receive informational material via network 108. Communications unit 114 may include various components, such as a network connection, a transmitter, a receiver, a transceiver, and/or a processor. The informational material disseminated by server 104 may be rendered at cellular telephone 102, for example, in a visual or audible form. Cellular telephone 102 may include output means, such as an output unit 116, configured to selectively render the informational material upon instruction or command of a user of cellular telephone 102. Output unit 116 may include various components, such as, for example, a display device, an audio speaker, and/or a dedicated processor. Cellular telephone 102 may also include processing means, such as a processing unit 118, which may include various components, including one or more processors. Cellular telephone 102 may further include a memory unit 122 in communication with processing unit 118 and communications unit 114.

Cellular telephone 102 may include a positioning system 120 in communication with communications unit 114 and processing unit 118. Positioning system may include, for example, hardware for performing trilateration. In one embodiment, trilateration hardware may include a transceiver and a processor. The transceiver may receive cellular signal strength information for at least three cellular antennas, and based on this information, the processor may determine a distance between cellular telephone 102 and the respective cellular antenna. Processor may then use information regarding spatial positioning of the respective cellular antennas to determine a position of cellular telephone 102, or may send the trilateration data elsewhere (for example, to computer 106) for location determination. In another embodiment, positioning system 120 may include a global positioning system (GPS) transceiver. In still another embodiment, positioning system 120 may determine location of cellular telephone 102 through ID of a cellular antenna (or other access point) to which the cellular telephone is connected.

In various instances, one or more of the entities associated with the informational material may be charged a fee related to the informational material, for example, in return for the right to have the informational material distributed. Along these lines, computer 106 may include processing means, such as a processing unit 124, and billing means, such as a billing unit 126. The processing unit 124 may include multiple components, including one or more processors. Billing unit 126 may also include multiple components, including one or more processors and possibly one or more databases. Billing unit 126 (in some cases in collaboration with other components, as will be discussed) may be configured to undertake a “billing impulse,” that is, to determine a charge (e.g., monetary) to the appropriate entity or entities associated with the informational material being disseminated by server 104 and, in some embodiments, transmit or deliver a notification of the charge to that entity (or a representative thereof). As will be discussed further below, the charge may be determined based at least in part on the subsequent movement of mobile terminals after having received and rendered the informational material, for example, in a specific direction, within or to within a specific area, or to a specific location. Computer 106 may communicate over network 108, for example, via a communications unit 128, which may include a network connection, transceiver, and/or a processor. Computer 106 may also include a memory unit 130, including, for example, one or more of a read-only memory, a random access memory, etc. In some embodiments, server 104 and computer 106 may be integrated into a single device, in which case communications unit 110 may coincide with communications unit 128, and memory 112 and memory unit 130 may be integrated. Processing unit 124 of computer 106 may be configured to obtain movement-based billing data, such as respective location data of cellular telephone 102 during and subsequent to the rendering of informational material at cellular telephone 102, parameters that may be used in conjunction with predefined billing criteria to calculate charges, or billing instructions. For example, predefined billing criteria may specify that a charge of $1.00 accrues for every minute spent by a mobile terminal within 10 meters of a specific location or in connection a specific network access point following the rendering of informational material. Processing unit 124 may then obtain a parameter specifying the number of minutes spent within the target area during the appropriate time interval, this being sufficient information to generate the final charge.

Location data can be generated and gathered in a variety of ways. For instance, processing unit 118 associated with cellular telephone 102 may be configured to cause, in response to the rendering of informational material, an indication of locations of cellular telephone 102 to be transmitted to processing unit 124 for subsequent use by billing unit 126. Transmissions from cellular telephone 102 may be via communications unit 114 and over network 108, and may relate to time periods during and subsequent to the rendering of the informational material at cellular telephone 102. That is, for times during the rendering of informational material (e.g., either the initial rendering, renderings that occur at certain times or locations, or every rendering), one or more indications of the location of cellular telephone 102 may be generated, and also at times subsequent to the rendering of informational material, one or more indications may again be generated. These latter indications may be in response to further renderings. The electronic address to which the transmission is sent, or location data/billing data address, may be specified as part of the informational material. The location indications may be transmitted contemporaneously with their generation, or may be stored, for example, in memory unit 122 and transmitted at a later time or times. The transmission of a location indication may be stored and/or transmitted in conjunction with a time stamp or may include or be associated with some other mechanism for identifying the time of generation. The transmission of a location indication may also be accompanied by or associated with one or more of an informational material ID, an informational material sender ID, and a cellular telephone user ID.

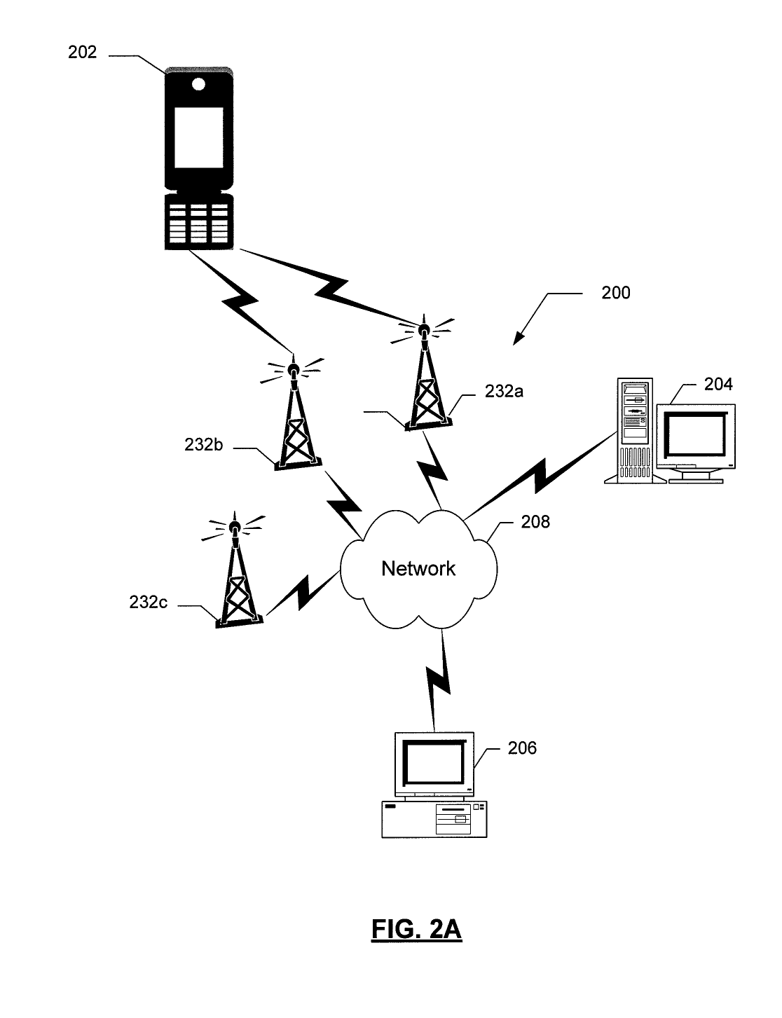

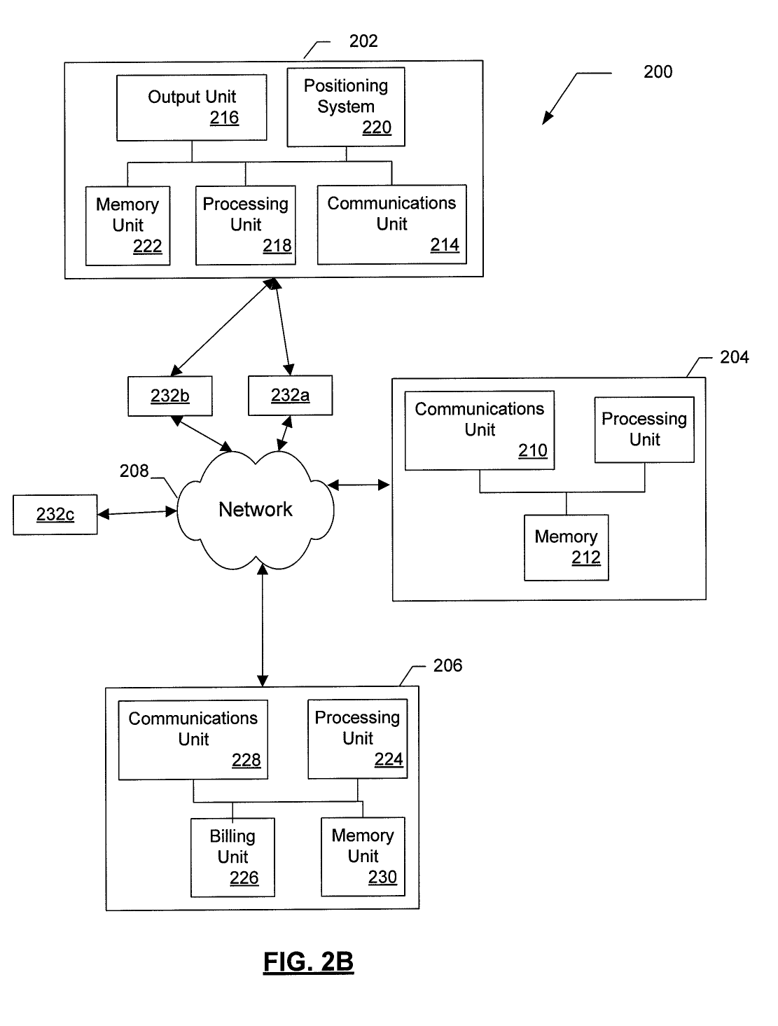

Referring to FIGS. 2A and 2B, the indication of mobile terminal location can be provided in a variety of ways. For example, network 208 may be accessible via any of multiple wireless network access points 232a-c, which may be of one or more varieties, such as cellular towers, cellular antennas, hotspots, etc. Processing unit 218 of cellular telephone 202 may be configured to cause, in response to the initial rendering of the informational material, transmission to billing unit 226 of respective communications at times during and subsequent to the initial rendering of the informational material. Alternatively, processing unit 218 may be configured to cause transmission of respective communications in response to each rendering of the informational material. The transmissions, for example, may be standardized messages transmitted as would be a typical voice call, data transfer, text/multimedia message, or electronic mail message to communications unit 228 associated with billing unit 226. In some embodiments, the communications are transmitted via communications unit 214. Billing unit 226 may then determine location data for cellular telephone 202 by respectively identifying, for each of the communications, a specific one of the cellular towers 232a-c via which cellular telephone 202 accessed network 208. Processing unit 224 of computer 206 may be configured to obtain the respective location data by respectively identifying, for each communication, the specific one of the cellular towers 232a-c via which cellular telephone 202 connected to network 208, thereby facilitating the location determination by billing unit 226. In other embodiments, cellular telephone 202 may identify and store locally an indication of the cellular tower 232a-c via which cellular telephone 202 has connected to network 208, these cellular tower identifications being later transmitted to computer 206 and billing unit 226. In some embodiments, the message may include some of the metadata information included in the informational material.

As an alternative for providing the indication of mobile terminal location, cellular telephone 202 may send one or more messages containing the pertinent location data. Positioning system 220 of cellular telephone 202 may provide location data, either continuously, repeatedly, or on demand. The location data may be transmitted as part of one or more messages by communications unit 214 when prompted by processing unit 218. Processing unit 218 may be configured to provide such prompt in response to the rendering of informational material at cellular telephone 202. Communications unit 228 of computer 206 may be configured to receive the messages including location data for cellular telephone 202, and processing unit 224 may be configured to obtain the location data from the messages, again facilitating the location determination by billing unit 226.

Referring to FIGS. 1A, 1B, 2A, and 2B, as mentioned earlier, billing unit 126, 226, as part of a “billing impulse,” may determine a charge to an entity associated with each piece of informational material. This charge may be determined based on movement of cellular telephone 102, 202 subsequent to the rendering of the informational material as indicated by the location data. However, the billing unit 126, 226 may be configured to determine the charge based on the movement of cellular telephone 102, 202 and charge in a variety of ways. For example, billing unit 126, 226 may be configured to relate the movement of cellular telephone 102, 202 subsequent to rendering of the informational material, perhaps for the first time, at cellular telephone 102, 202 and relative to a “product location” of a product to which the informational material relates. “Product location” may be defined as appropriate for a specific application, and in different instances may refer, for example, to the physical location of a product being offered for sale or the location at which the product may be ordered (e.g., as where the product is a service). This charge-movement relationship may be appropriate, for example, in attempting to correlate a charge to the effectiveness of the informational material in inducing those confronted by the informational material to further consider or purchase the product. In some embodiments, informational material may be associated with multiple product locations.

Other variations of the relationship between cellular telephone movement and charge are also possible and may be specified by a rule to be disseminated to cellular telephone 102, 202 and/or computer 106, 206. For example, processing unit 124, 224 may be configured to obtain the location data of cellular telephone 102, 202 during and for a specified time subsequent to the rendering of informational material, thereby establishing a time limitation on the charge-movement relationship. Such a relationship may be useful, for example, in separating those movements of cellular telephone 102, 202 that may be properly attributed to the influence of the informational material and those movements that are otherwise unrelated to the informational material. As another example, billing unit 126, 226 may only accrue charges when cellular telephone 102, 202 moves within a certain radius of a specified location, such as a product location, and then perhaps only if the cellular telephone 102, 202 remains within the certain radius for a specified length of time. In such a case, the specified radius acts as a billing impulse-triggering location, its attainment by cellular telephone 102, 202 following rendering prompting a billing impulse. In some embodiments, the certain radius may be a series of roughly concentric radii around the product location, and the movement of cellular telephone 102, 202 into progressively smaller radii around a product location causes correspondingly higher charges to be generated. In some embodiments, the certain radius may be the radius of a network access point to which the cellular telephone 102, 202 is connected to.

In yet another example, a billing impulse is triggered when, at some time following the initial rendering of the informational material, the informational material is rendered while the cell phone 102, 202 is at or proximal to a specified location, such as a product location. In still other examples, billing unit 126, 226 may determine a charge as a function of other factors in addition to movement of cellular telephone 102, 202, such as the identity of the entity associated with the informational material and being charged, the day of the week or time of day in which the informational material is rendered or in which the movement of cellular telephone 102, 202 occurs, and/or the type of informational material (perhaps as determined from an informational material ID).

In some embodiments, communications unit 110, 210 of server 104, 204 may be configured to disseminate at least one rule associated with the informational material, the rule specifying the relationship between the charge and the movement of cellular telephone 102, 202. The relationship could be specified in a number of ways. For example, the rule could specify a functional relationship between cellular telephone movement and charge, could specify parameters for use by a downstream application in calculating a charge (e.g., at billing unit 126, 226), and/or could include executable code for implementing or facilitating the implementation of the billing. The rule may be stored in memory 112, 212 and sent from server 104, 204 to computer 106, 206, possibly for storage in memory unit 130, 230, such that the rule may be implemented by billing unit 126, 226 and charges may be determined appropriately and individually for each piece of informational material. In another embodiment, some or all of the rules may be maintained in computer 106, 206, for example, in memory unit 130, 230, for utilization by billing unit 126. This may obviate some or all of the need for rules to be transmitted by server 104, 204.

Rules may also, or instead, be provided to cellular telephone 102, 202, perhaps along with informational material. For example, the rule may be stored in memory unit 122, 222, such that cellular telephone 102, 202 may, for example, determine the appropriate times to send location information to computer 106, 206. In one embodiment, cellular telephone 102, 202 may utilize the rule or rules stored therein to perform billing functions, acting to track movement with respect to one or more product locations associated with the various informational material stored in cellular telephone 102, 202 and/or accrue charges that are subsequently reported back to computer 106, 206, for example, as billing instructions. In another embodiment, cellular telephone 102, 202, may provide to computer 106, 206 billing parameters indicating that predefined criteria for a specified charge have been met. In such cases, the cellular telephone 102, 202 would initiate a billing impulse and may not send location data to computer 106, 206, but would obtain such location data and utilize the data locally at cellular telephone 102, 202. Along these lines, cellular telephone 102, 202 may store in memory unit 122 an informational material monitoring application that may be executed by processing unit 118 in accomplishing the above tasks (e.g., monitoring rules, cellular telephone location, billing impulse-triggering locations, etc.).

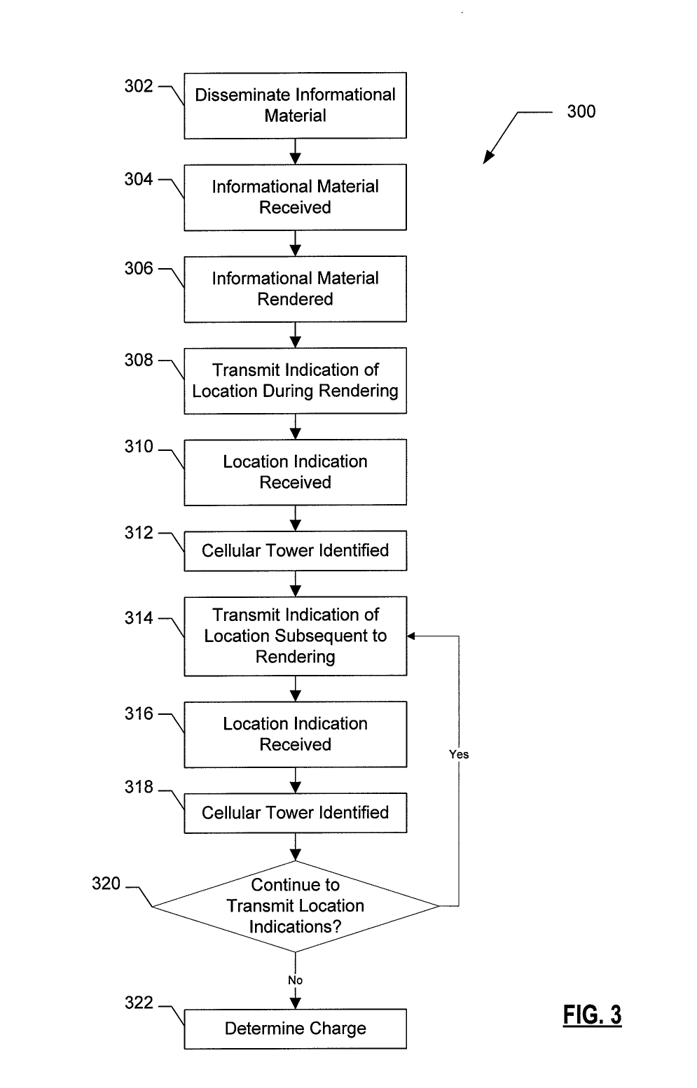

Referring to FIG. 3, therein is a flowchart representing a method 300 for utilizing the communications system 100 shown schematically in FIGS. 2A and 2B to determine a charge related to informational material, the method being in accordance with one embodiment of the invention. Method 300 begins at Block 302, where informational material is disseminated, for example, by server 204 via communications unit 214 and network 208, to at least one mobile terminal, such as cellular telephone 202. The informational material may include or be accompanied by an informational material ID and/or a rule related to billing, etc. At Block 304, the informational material, rule, etc. is received by cellular telephone 202, for example, via communications unit 214, and at Block 306 the informational material is rendered at cellular telephone 202.

In response to the rendering of the informational material, at Block 308, an indication of locations of cellular telephone 202 during the rendering of the informational material is caused, for example, by processing unit 218, to be transmitted from cellular telephone 202 to computer 206 along with the informational material ID. A time stamp related to the time of rendering may also be transmitted, as may be the rule, etc. For example, at Block 308, cellular telephone 202 may send a message via a first access point 232a over network 208 to billing unit 226. In some embodiments, such message transmission may be selective, such that a user of cellular telephone 202 may be given an option to prevent the transmission, while in other embodiments, the message may be transmitted automatically. At Block 310, the message is received by computer 206, for example, by communications unit 228, and processing unit 224 identifies the access point 232a via which the message was sent at Block 312 and provides the information to billing unit 226. In some embodiments, processing unit 224 may have access to a database correlating access point ID and the physical location of each access point, such that this information may be utilized by billing unit 226 in determining a charge.

At Block 314, also in response (although perhaps not immediately) to the rendering of the informational material at cellular telephone 202, an indication of locations of cellular telephone 202 subsequent to the rendering of the informational material, for example, a message, is caused to be transmitted from cellular telephone 202 via a second access point 232b to computer 206. Second access point 232b may be part of the same type of network as first access point 232a, or may be part of a different type of network. At Block 316, the message is received by computer 206, for example, by communications unit 228, and processing unit 224 identifies the second access point 232b via which the message was sent at Block 318 and provides the information to billing unit 226. This process of sending messages to report position is repeated until it is decided, at Block 320, that such reporting is no longer necessary. The frequency of the transmissions and the time at which transmissions are discontinued may be specified, for example, by the rule.

At Block 322, a charge to an entity associated with the informational material is determined, for example, by billing unit 226. The charge is based, at least in part, on movement of cellular telephone 202 subsequent to rendering of the informational material, this movement being indicated by the location data. The specific relationship between movement of cellular telephone 202 and charge may be specified by the rule, which may be received by billing unit 226 either from cellular telephone 202 or from server 204.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, although the processing unit and the billing unit have generally been described as being part of a single computer, it is also possible for these components to be independent of one another. Also, while “network access points” has been exemplified above by cellular towers, network access points is not limited to this embodiment, and may include, for example, any wireless telecommunications transceivers, short range wireless communications transceivers (e.g., Bluetooth, WiBree, IrDA, etc.), and/or Ethernet connections. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processing unit configured to obtain movement-based billing data associated with movement of at least one mobile terminal subsequent to at least one rendering of informational material at the at least one mobile terminal; and
a billing unit configured to determine a charge to an entity associated with the informational material based at least in part on movement of the at least one mobile terminal subsequent to the at least one rendering of the informational material as indicated by the movement-based billing data.

2. An apparatus according to claim 1, wherein said processing unit is configured to obtain movement-based billing data in the form of billing instructions from the at least one mobile terminal.

3. An apparatus according to claim 1, wherein said processing unit is configured to obtain from the at least one mobile terminal movement-based billing data in the form of billing parameters related to predefined billing criteria.

4. An apparatus according to claim 1, wherein said processing unit is configured to obtain movement-based billing data in the form of respective location data of at least one mobile terminal during and subsequent to the at least one rendering of informational material at the at least one mobile terminal.

5. An apparatus according to claim 4, wherein said processing unit is configured to obtain respective location data of the at least one mobile terminal during first and second renderings of the informational material at the at least one mobile terminal.

6. An apparatus according to claim 4, wherein said billing unit is configured to determine the charge based on mobile terminal movement subsequent to the at least one rendering of the informational material at the at least one mobile terminal and relative to a product location of a product to which the informational material is related.

7. An apparatus according to claim 4, wherein said apparatus is associated with a network accessible to the at least one mobile terminal via any of multiple network access points, and wherein said processing unit is configured to obtain respective location data of the at least one mobile terminal during and subsequent to the at least one rendering of the informational material at the at least one mobile terminal by respectively identifying, for times during and subsequent to the at least one rendering of the informational material, a specific one of the network access points via which the at least one mobile terminal is connected to the network.

8. An apparatus according to claim 4, further comprising a communications unit configured to disseminate the informational material to the at least one mobile terminal.

9. An apparatus according to claim 8, wherein said communications unit is configured to receive messages from the at least one mobile terminal, at least some of the messages including location data for the at least one mobile terminal, and said processing unit is configured to obtain the location data from the messages.

10. An apparatus according to claim 8, wherein said communications unit is further configured to disseminate at least one rule associated with the informational material, the at least one rule specifying a relationship between the charge to the entity associated with the informational material and movement of the at least one mobile terminal subsequent to the at least one rendering of the informational material.

11. An apparatus according to claim 4, wherein said processing unit is configured to obtain the location data of the at least one mobile terminal during and for a specified time subsequent to the at least one rendering of the informational material at the at least one mobile terminal.

12. An apparatus according to claim 4, further comprising a memory unit configured to store at least one rule specifying a relationship between the charge to the entity associated with the informational material and movement of the at least one mobile terminal subsequent to the at least one rendering of the informational material.

13. An apparatus according to claim 12, wherein said memory is configured to store multiple rules each specifying the charge to the entity associated with the informational material as a function of at least the movement of the at least one mobile terminal subsequent to the at least one rendering of the informational material and an identity of the specified entity.

14. An apparatus according to claim 1, wherein said processing unit includes processing means for obtaining movement-based billing data associated with movement of at least one mobile terminal subsequent to the at least one rendering of informational material at the at least one mobile terminal, and wherein said billing unit includes billing means for determining a charge to an entity associated with the informational material based at least in part on movement of the at least one mobile terminal subsequent to the at least one rendering of the informational material as indicated by the movement-based billing data.

15. A method comprising:
obtaining movement-based billing data associated with movement of at least one mobile terminal subsequent to at least one rendering of informational material at the at least one mobile terminal; and
determining a charge to an entity associated with the informational material based at least in part on movement of the at least one mobile terminal subsequent to the at least one rendering of the informational material as indicated by the movement-based billing data.

16. A method according to claim 15, wherein said obtaining movement-based billing data includes obtaining movement-based billing data in the form of billing instructions from the at least one mobile terminal.

17. A method according to claim 15, wherein said obtaining movement-based billing data includes obtaining from the at least one mobile terminal movement-based billing data in the form of billing parameters related to predefined billing criteria.

18. A method according to claim 15, wherein said obtaining movement-based billing data includes obtaining movement-based billing data in the form of respective location data of at least one mobile terminal during and subsequent to the at least one rendering of informational material at the at least one mobile terminal.

19. A method according to claim 18, wherein said obtaining respective location data of at least one mobile terminal during and subsequent to the at least one rendering of informational material at the at least one mobile terminal includes obtaining respective location data of the at least one mobile terminal during first and second renderings of the informational material at the at least one mobile terminal.

20. A method according to claim 18, wherein said determining the charge includes determining the charge based on mobile terminal movement subsequent to the at least one rendering of the informational material at the at least one mobile terminal and relative to a product location of a product to which the informational material is related.

21. A method according to claim 18, wherein said obtaining respective location data of the at least one mobile terminal includes respectively identifying, for times during and subsequent to the at least one rendering of the informational material, a specific one of multiple available network access points via which the at least one mobile terminal is connected to a network.

22. A method according to claim 18, further comprising disseminating the informational material to the at least one mobile terminal.

23. A method according to claim 22, wherein said disseminating the informational material to the at least one mobile terminal includes disseminating at least one rule associated with the informational material, the at least one rule specifying a relationship between the charge to the entity associated with the informational material and movement of the at least one mobile terminal subsequent to the at least one rendering of the informational material.

24. A method according to claim 18, further comprising storing at least one rule specifying a relationship between the charge to the entity associated with the informational material and movement of the at least one mobile terminal subsequent to the at least one rendering of the informational material.

25. A method according to claim 24, wherein said storing the at least one rule specifying a relationship between the charge to the entity associated with the informational material and movement of the at least one mobile terminal subsequent to the at least one rendering of the informational material includes storing multiple rules each specifying the charge to the entity associated with the informational material as a function of at least the movement of the at least one mobile terminal subsequent to the at least one rendering of the informational material and an identity of the specified entity.

26. A computer program product comprising a computer-readable storage medium having computer-readable program code portions stored therein, the computer-readable program code portions comprising:
a first executable code portion for obtaining movement-based billing data associated with movement of at least one mobile terminal subsequent to at least one rendering of informational material at the at least one mobile terminal; and
a second executable code portion for determining a charge to an entity associated with the informational material based at least in part on movement of the at least one mobile terminal subsequent to the at least one rendering of the informational material as indicated by the movement-based billing data.

27. A computer program product according to claim 26, wherein said first executable code portion for obtaining movement-based billing data includes an executable code portion for obtaining movement-based billing data in the form of billing instructions from the at least one mobile terminal.

28. A computer program product according to claim 26, wherein said first executable code portion for obtaining movement-based billing data includes an executable code portion for obtaining from the at least one mobile terminal movement-based billing data in the form of billing parameters related to predefined billing criteria.

29. A computer program product according to claim 26, wherein said first executable code portion for obtaining movement-based billing data includes an executable code portion for obtaining movement-based billing data in the form of respective location data of at least one mobile terminal during and subsequent to the at least one rendering of informational material at the at least one mobile terminal.

30. A computer program product according to claim 29, wherein said executable code portion for obtaining respective location data of at least one mobile terminal during and subsequent to the at least one rendering of the informational material at the at least one mobile terminal includes an executable code portion for obtaining respective location data of the at least one mobile terminal during first and second renderings of the informational material at the at least one mobile terminal.

31. A computer program product according to claim 29, wherein said second executable code portion for determining the charge includes an executable code portion for determining the charge based on mobile terminal movement subsequent to the at least one rendering of the informational material at the at least one mobile terminal and relative to a product location of a product to which the informational material is related.

32. A computer program product according to claim 29, wherein said executable code portion for obtaining respective location data of the at least one mobile terminal includes an executable code portion for respectively identifying, for times during and subsequent to the at least one rendering of the informational material, a specific one of multiple available network access points via which the at least one mobile terminal is connected to a network.

33. A computer program product according to claim 29, further comprising a third executable code portion for disseminating the informational material to the at least one mobile terminal.

34. A computer program product according to claim 33, wherein said third executable code portion for disseminating the informational material to the at least one mobile terminal includes an executable code portion for disseminating at least one rule associated with the informational material, the at least one rule specifying a relationship between the charge to the entity associated with the informational material and movement of the at least one mobile terminal subsequent to the at least one rendering of the informational material.

35. A computer program product according to claim 29, further comprising a third executable code portion for storing at least one rule specifying a relationship between the charge to the entity associated with the informational material and movement of the at least one mobile terminal subsequent to the at least one rendering of the informational material.

36. A computer program product according to claim 35, wherein said third executable code portion for storing the at least one rule specifying a relationship between the charge to the entity associated with the informational material and movement of the at least one mobile terminal subsequent to the at least one rendering of the informational material includes an executable code portion for storing multiple rules each specifying the charge to the entity associated with the informational material as a function of at least the movement of the at least one mobile terminal subsequent to the at least one rendering of the informational material and an identity of the specified entity.

37. An apparatus comprising:
a communications unit configured to receive informational material via a network;
an output unit configured to render the informational material; and
a processing unit configured to cause, in response to at least one rendering of the informational material, movement-based billing data associated with movement of said apparatus subsequent to the at least one rendering of the informational material to be transmitted via said communications unit over the network to a billing unit.

38. An apparatus according to claim 37, wherein said processing unit is configured to cause, in response to the at least one rendering of the informational material, movement-based billing data in the form of billing instructions to be transmitted via said communications unit over the network to the billing unit.

39. An apparatus according to claim 37, wherein said processing unit is configured to cause, in response to at least one rendering of the informational material, movement-based billing data in the form of billing parameters related to predefined billing criteria to be transmitted via said communications unit over the network to the billing unit.

40. An apparatus according to claim 37, wherein said processing unit is configured to cause, in response to at least one rendering of the informational material, movement-based billing data in the form of respective location data of said apparatus during and subsequent to the at least one rendering of informational material at said apparatus to be transmitted via said communications unit over the network to a billing unit.

41. An apparatus according to claim 40, wherein said processing unit is configured to cause, in response to first and second renderings of the informational material, respective location data of said apparatus during the first and second renderings of the informational material at said apparatus to be transmitted via said communications unit over the network to a billing unit.

42. An apparatus according to claim 40, wherein the network is accessible via any of multiple network access points, and wherein said processing unit is configured to cause, in response to the at least one rendering of the informational material, transmission to the billing unit via said communications unit of respective communications at times during and subsequent to the at least one rendering of the informational material, the billing unit determining location data for said apparatus by respectively identifying, for each of the communications, a specific one of the network access points via which said communications unit accessed the network.

43. An apparatus according to claim 40, further comprising a positioning system in communication with said communications unit, wherein said processing unit is configured to cause, in response to the at least one rendering of the informational material, transmission via said communications unit of respective location data for said apparatus during and subsequent to the at least one rendering of the informational material over the network to the billing unit, the respective location data being generated by said positioning system.

44. An apparatus according to claim 43, wherein said processing unit is configured to cause, in response to the at least one rendering of the informational material, respective location data for said apparatus during and subsequent to the at least one rendering of the informational material to be transmitted via said communications unit substantially immediately after a time to which the respective location data pertain.

45. An apparatus according to claim 40, further comprising a memory unit in communication with said processing unit and said communications unit, wherein said communications unit is configured to receive, and said memory unit is configured to store, at least one rule associated with the informational material, the at least one rule specifying a relationship between a charge to an entity associated with the informational material and movement of said apparatus subsequent to the at least one rendering of the informational material.

46. An apparatus according to claim 45, wherein said processing unit is configured to execute instructions associated with the rule in causing the respective location data of said apparatus to be transmitted via said communications unit over the network to the billing unit.

47. An apparatus according to claim 37, wherein said communications unit includes communications means for receiving informational material via a network, wherein said output unit includes output means for rendering the informational material, and said processing unit includes processing means for causing, in response to the at least one rendering of the informational material, movement-based billing data associated with movement of said apparatus subsequent to the at least one rendering of the informational material to be transmitted via said communications unit over the network to the billing unit.

48. A method comprising:
receiving informational material at an apparatus via a network;
rendering the informational material at least once at the apparatus; and
causing, in response to said rendering the informational material at least once, movement-based billing data associated with movement of the apparatus subsequent to said rendering at least once of the informational material to be transmitted over the network to a billing unit.

49. A method according to claim 48, wherein said causing movement-based billing data to be transmitted over the network to a billing unit includes causing, in response to said rendering the informational material at least once, movement-based billing data in the form of billing instructions to be transmitted over the network to the billing unit.

50. A method according to claim 48, wherein said causing movement-based billing data to be transmitted over the network to a billing unit includes causing, in response to said rendering the informational material at least once, movement-based billing data in the form of billing parameters related to predefined billing criteria to be transmitted over the network to the billing unit.

51. A method according to claim 48, wherein said causing movement-based billing data to be transmitted over the network to a billing unit includes causing, in response to said rendering the informational material at least once, movement-based billing data in the form of respective location data of the apparatus during and subsequent to said rendering the informational material at least once at the apparatus to be transmitted over the network to a billing unit.

52. A method according to claim 51, wherein said rendering the informational material at least once at the apparatus includes rendering the informational material as at least a first rendering and a second rendering, and wherein said causing movement-based billing data to be transmitted over the network to a billing unit includes causing, in response to said rendering the informational material as at least a first rendering and a second rendering, respective location data of the apparatus during the first and second renderings of the informational material at the apparatus to be transmitted over the network to a billing unit.

53. A method according to claim 51, wherein the network is accessible via any of multiple network access points, and wherein said causing movement-based billing data to be transmitted over the network to a billing unit includes causing, in response to said rendering the informational material at least once, transmission to the billing unit of respective communications at times during and subsequent to said rendering the informational material at least once, from which communications location data may be determined via the respective identification of specific ones of the network access points from which each of the communications originated.

54. A method according to claim 51, wherein said causing movement-based billing data to be transmitted over the network to a billing unit includes causing, in response to said rendering the informational material at least once, transmission over the network to the billing unit of respective location data for the apparatus during and subsequent to rendering at least once the informational material, the respective location data being generated by a positioning system of the apparatus.

55. A method according to claim 54, wherein said causing movement-based billing data to be transmitted over the network to a billing unit includes causing, in response to said rendering the informational material at least once, respective location data for the apparatus during and subsequent to rendering the informational material at least once to be transmitted substantially immediately after a time to which the respective location data pertain.

56. A method according to claim 51, further comprising receiving at least one rule associated with the informational material and storing the at least one rule, the at least one rule specifying a relationship between a charge to an entity associated with the informational material and movement of the apparatus subsequent to the at least one rendering of the informational material.

57. A method according to claim 56, wherein said causing movement-based billing data to be transmitted over the network to the billing unit includes executing instructions associated with the rule.

58. A computer program product comprising a computer-readable storage medium having computer-readable program code portions stored therein, the computer-readable program code portions comprising:
a first executable code portion for receiving informational material at an apparatus via a network;
a second executable code portion for rendering the informational material at least once at the apparatus; and
a third executable code portion for causing, in response to said rendering the informational material at least once, movement-based billing data associated with movement of the apparatus subsequent to said rendering at least once of the informational material to be transmitted over the network to a billing unit.

59. A computer program product according to claim 58, wherein said third executable code portion for causing movement-based billing data to be transmitted over the network to a billing unit includes an executable code portion for causing, in response to said rendering the informational material at least once, movement-based billing data in the form of billing instructions to be transmitted over the network to the billing unit.

60. A computer program product according to claim 58, wherein said third executable code portion for causing movement-based billing data to be transmitted over the network to a billing unit includes an executable code portion for causing, in response to said rendering the informational material at least once, movement-based billing data in the form of billing parameters related to predefined billing criteria to be transmitted over the network to the billing unit.

61. A computer program product according to claim 58, wherein said third executable code portion for causing movement-based billing data to be transmitted over the network to a billing unit includes an executable code portion for causing, in response to said rendering the informational material at least once, movement-based billing data in the form of respective location data of the apparatus during and subsequent to said rendering the informational material at least once at the apparatus to be transmitted over the network to a billing unit.

62. A computer program product according to claim 61, wherein said second executable code portion for rendering the informational material at least once at the apparatus includes an executable code portion for rendering the informational material as at least a first rendering and a second rendering, and wherein said third executable code portion for causing movement-based billing data to be transmitted over the network to a billing unit includes an executable code portion for causing, in response to said rendering the informational material as at least a first rendering and a second rendering, respective location data of the apparatus during the first and second renderings of the informational material at the apparatus to be transmitted over the network to a billing unit.

63. A computer program product according to claim 61, wherein the network is accessible via any of multiple network access points, and wherein said third executable code portion for causing movement-based billing data to be transmitted over the network to a billing unit includes an executable code portion for causing, in response to said rendering the informational material at least once, transmission to the billing unit of respective communications at times during and subsequent to said rendering the informational material at least once, from which communications location data may be determined via the respective identification of specific ones of the network access points from which each of the communications originated.

64. A computer program product according to claim 61, wherein said third executable code portion for causing movement-based billing data to be transmitted over the network to a billing unit includes an executable code portion for causing, in response to said rendering the informational material at least once, transmission over the network to the billing unit of respective location data for the apparatus during and subsequent to rendering at least once the informational material, the respective location data being generated by a positioning system of the apparatus.

65. A computer program product according to claim 64, wherein said third executable code portion for causing movement-based billing data to be transmitted over the network to a billing unit includes an executable code portion for causing, in response to said rendering the informational material at least once, respective location data for the apparatus during and subsequent to rendering the informational material at least once to be transmitted substantially immediately after a time to which the respective location data pertain.

66. A computer program product according to claim 61, further comprising a fourth executable code portion for receiving at least one rule associated with the informational material and a fifth executable code portion for storing the at least one rule, the at least one rule specifying a relationship between a charge to an entity associated with the informational material and movement of the apparatus subsequent to the at least one rendering of the informational material.

67. A system comprising:
at least a first apparatus including:
a communications unit configured to receive informational material via a network;
an output unit configured to render the informational material; and
a processing unit configured to cause, in response to at least one rendering of the informational material, movement-based billing data associated with movement of said first apparatus subsequent to the at least one rendering of the informational material to be transmitted via said communications unit over the network; and
a second apparatus including:
a processing unit configured to obtain the movement-based billing data from over the network; and
a billing unit configured to determine a charge to an entity associated with the informational material based at least in part on movement of said first apparatus subsequent to the at least one rendering of the informational material as indicated by the movement-based billing data.

68. A system according to claim 67, wherein said second apparatus further comprises a communications unit configured to disseminate the informational material to said first apparatus.

69. A system according to claim 68, wherein said communications unit of said second apparatus is further configured to disseminate at least one rule associated with the informational material, the at least one rule specifying a relationship between the charge to the entity associated with the informational material and movement of said first apparatus subsequent to the at least one rendering of the informational material.

70. A method comprising:
receiving informational material at an apparatus via a network;
rendering the informational material at the apparatus;
causing, in response to at least one rendering of the informational material, movement-based billing data associated with movement of the apparatus subsequent to the at least one rendering of the informational material to be transmitted over the network;
obtaining the movement-based billing data from over the network; and
determining a charge to an entity associated with the informational material based at least in part on movement of the apparatus subsequent to the at least one rendering of the informational material as indicated by the movement-based billing data.

71. A method according to claim 70, further comprising disseminating the informational material to the apparatus.

72. A method according to claim 71, further comprising disseminating at least one rule associated with the informational material, the at least one rule specifying a relationship between the charge to the entity associated with the informational material and movement of the apparatus subsequent to the at least one rendering of the informational material.
